(19) United States
(12) Patent Application Publication
(10) Pub. No.: US 2024/0346604 A1
(43) Pub. Date: Oct. 17, 2024

(54) MAPPING MICRO-VIDEO HASHTAGS TO CONTENT CATEGORIES

(71) Applicant: eBay Inc., San Jose, CA (US)

(72) Inventors: Dingxian WANG, Newcastle, WA (US); Guandong XU, Oatley (AU); Hongxu CHEN, Ryde (AU); Li HE, Beijing (CN)

(21) Appl. No.: 18/683,171

(22) PCT Filed: Aug. 13, 2021
(86) PCT No.: PCT/CN2021/112485

§ 371 Date: Feb. 12, 2024

(51) Int. Cl. G06Q 50/00; G06F 16/78

(52) U.S. Cl. CPC G06Q 50/01; G06F 16/7867

(57) ABSTRACT

Technologies are shown for mapping micro-video hashtags to content categories that involve collecting content categories from a content service, collecting micro-video, hashtags and user interaction semantic data from a micro-video service, determining a correlation of a content category to the micro-video, hashtags and user interaction semantic data using a multi-layer graph convolution network, and providing the hashtags correlated with the content category to the content service. The correlation can be determined by processing the semantic data with a concatenation layer and a full connected layer to produce a user-specific micro-video and hashtag representations. Similarity scores for determining correlation can be calculated from category content and a dot product of the representations. A content service can process a hashtag received from a micro-video application by identifying a content category correlated to the received hashtag, identifying content from the correlated category, and providing the identified content to the micro-video application for presentation.

### BACKGROUND

The disclosed technology relates to hashtags in micro-video sharing platforms. In social networks applications, hashtags are frequently used to annotate, categorize, and describe social network posts according to users' preferences. Micro-video applications have recently emerged that combine textual, audio, and video media data types and can reflect the user's cognitive, emotional, and personalized perception of target content data or items, which can provide an opportunity to capture user holistic intention. Hashtags can be associated with micro-video segments. These hashtags generally relate to the interests of viewers of the segments.

Often, a user provides hashtags to a post, such as a micro-video, that the user regards as content in which the user is interested. Many current solutions exist that automatically recommend hashtags to users based on the content of the posts. Some of these technologies rely on modeling the interactions between hashtags and posts or the interactions between users and hashtags to make personalized hashtag recommendations to the user. For example, hashtag recommendations can be based on historical tweets, hashtags used by a user, and social interactions of the user to search the tweets of similar users in order to generate hashtag recommendations.

It is with respect to these and other considerations that the disclosure made herein is presented.

### SUMMARY

The disclosed technology is directed toward mapping micro-video hashtags to content categories from a content provider using a graph convolution network based correlation module.

In general terms, the disclosed technology obtains content categories from a content service and collects micro-video, hashtags and user interaction semantic data from a micro-video service. A graph convolution network is utilized to determine a correlation between a content category and the collected micro-video, hashtags and user interaction semantic data. Hashtags correlated with the content category are provided to the content service. The content service can utilize the hashtags correlated with the content category to serve content from the content category for the hashtags.

In certain simplified examples of the disclosed technologies, methods, systems or computer readable media for mapping micro-video hashtags to content categories in accordance with the disclosed technology involve collecting content categories from a content service, collecting micro-video, hashtags and user interaction semantic data from a micro-video service, determining a correlation of at a content category to the micro-video, hashtags and user interaction semantic data using a multi-layer graph convolution network, and providing the hashtags correlated with the content category to the content service.

Certain examples also involve determining popularity levels for the hashtags, determining a ranking of the hashtags based on popularity levels and relevance, and the operation of providing the hashtags correlated with the content category to the content service comprises providing the ranking of the hashtags correlated with the content category to the content service.

In particular examples, the operation of determining a correlation of a content category to the micro-video, hashtags and user interaction semantic data using a graph convolution network involves processing the micro-video, hashtag and user interaction semantic data with a concatenation layer of the multi-layer graph convolution network, processing data output from the concatenation layer with a full connected layer of the multi-layer graph convolution network to produce a user-specific micro-video representation and a user-specific hashtag representation, and calculating similarity scores for hashtags from content from the content category and a product of the micro-video semantic features and user-specific hashtags, and determining the correlation of hashtags to the content category from the similarity scores. In certain ones of these examples, the operation of providing the hashtags correlated with the content category to the content service includes providing the similarity scores for the hashtags to the content service.

Other examples of the disclosed technology involve receiving a hashtag from a micro-video application, identifying a content category correlated to the received hashtag, identifying content from the correlated category, and providing the identified content to the micro-video application for presentation.

In particular examples, the content service can be an information platform, where the content category can be an information category, and the content data from the content category can be include information items.

In certain other examples, the content service can be an eCommerce platform, the content category can be a product category, and the content data from the content category can include product information items.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items.

FIG. 1A is an architectural diagram showing an illustrative example of an architecture suitable for application of the disclosed technology for mapping micro-video hashtags to content categories;

FIG. 1B is a functional block diagram showing an illustrative example of a mapping service for mapping micro-video hashtags to content categories in accordance with the disclosed technology;

FIG. 2 is a schematic diagram illustrating a simplified example of a multi-layer graph convolution network model of the interactions among categories, micro-videos, hashtags and users in accordance with the disclosed technology;

FIG. 3 is a schematic diagram for an example of a multi-layer graph convolution network based approach for calculating a similarity score in the correlation module for categories provided by a content service in accordance with the disclosed technology;

FIG. 4A is a control flow diagram illustrating an example of a process for mapping micro-video hashtags to content categories using a multi-layer graph convolution network in accordance with the disclosed technology;

FIG. 4B is a control flow diagram illustrating an example of a process for determining similarity scores for content categories and hashtags using a multi-layer graph convolution network in accordance with the disclosed technology;

FIG. 4C is a control flow diagram illustrating an example of a process for receiving and storing hashtags correlated to content categories in accordance with the disclosed technology;

FIG. 4D is a control flow diagram illustrating an example of a process for serving content from categories correlated with hashtags in accordance with the disclosed technology;

FIG. 5 is a computer architecture diagram illustrating an illustrative computer hardware and software architecture for a computing system capable of implementing aspects of the techniques and technologies presented herein;

FIG. 6 is a diagram illustrating a distributed computing environment capable of implementing aspects of the techniques and technologies presented herein; and

FIG. 7 is a computer architecture diagram illustrating a computing device architecture for a computing device capable of implementing aspects of the techniques and technologies presented herein.

### DETAILED DESCRIPTION

The following Detailed Description describes technologies for mapping micro-video hashtags to content categories. For example, a list of hashtags and a set of content categories, such as categories of news items or products, can be input to a neural network to produce a mapping between the hashtag list and the content categories, e.g. a mapping between the hashtags and the news content categories or product content categories.

The disclosed technology relates to hashtags in micro-video sharing platforms. In social networks applications, hashtags are frequently used to annotate, categorize, and describe social network posts according to users' preferences. Micro-video applications have recently emerged that combine textual, audio, and video media data types and can reflect the user's cognitive, emotional, and personalized perception of target content data or items, which can provide an opportunity to capture user holistic intention. Hashtags can be associated with micro-video segments. These hashtags relate to the interests of viewers of the segments.

The disclosed technology is generally directed toward mapping micro-video hashtags to content categories from a content service using a graph convolution network based correlation module. In one example, the disclosed technology utilizes graph convolutional techniques in graph neural networks to create a model for complex interactions between users, the hashtags and the micro-videos to identify a correlation between content categories and micro-video hashtags.

For example, the interactions between users and the micro-videos and content categories of an information service platform can be input to a neural network to learn a correlation between the content categories and the hashtag list. In another example, the interactions between users and the micro-videos and product categories of an eCommerce platform can be input to a neural network to learn a correlation between the product categories and the hashtag list.

The resulting correlation model can be used to produce content recommendations based on a hashtag associated with a micro-video segment that a user is viewing, e.g. product recommendations can be presented while a user is viewing a micro-video. In one particular example, tag-level popularity can be utilized to recommend relevant hashtags for a content service, e.g. an information platform such as a news feed or educational platform, a social network platform, or an eCommerce platform.

In examples of the disclosed technology, a database can be generated from online public datasets collected from one or more social network platforms, such as a micro-video sharing platform. This database can include category information from a content service platform along with hashtag textual and user interaction information from one or more micro-video platforms.

In one example, a correlation module can be created utilizing a graph convolutional network to create a model of the complicated interactions among content categories, micro-videos, hashtags and users. In this model, the users, hashtags, and micro-videos can be three types of nodes in a graph and they can be linked based on their direct associations. In other words, user nodes can be connected to their historical micro-video nodes and used hashtag nodes, and hashtag nodes can be connected to their accompanied micro-video nodes and corresponding user nodes. The user nodes and hashtag nodes can be represented in a graph convolutional network.

A technical advantage of the disclosed technology is that it can improve content recommendations to a user by identifying correlation between content categories and hashtags based on complex modeling of micro-video, hashtags and user interaction semantics using a multi-layer graph convolution network. The disclosed technology can be used to improve the relevance of informational content suggested or presented to a user.

Another technical advantage of the disclosed technology is that the complex modeling can continually learn micro-video and hashtag intrinsic information from changes in the micro-video, hashtags and user interaction semantics.

These are simplified examples and many factors may be considered in mapping micro-video hashtags to content categories in accordance with the disclosed technology.

As will be described in more detail herein, it can be appreciated that implementations of the techniques and technologies described herein may include the use of solid state circuits, digital logic circuits, computer components, and/or software executing on one or more input devices. Signals described herein may include analog and/or digital signals for communicating a changed state of the data file or other information pertaining to the data file.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including multiprocessor systems, mainframe computers, microprocessor-based or programmable consumer electronics, minicomputers, hand-held devices, and the like.

By the use of the technologies described herein, micro-video hashtags can be mapped to content categories to improve the relevance of content recommended, suggested or served to a user as the user view micro-video segments. The improved relevance of the content can result in the user encountering new content of interest to the user. Other technical effects other than those mentioned herein can also be realized from implementation of the technologies disclosed herein.

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for mapping micro-video hashtags to content categories using a multi-layer graph convolution network will be described. As will be described in more detail below with respect to the figures, there are a number of applications and services that may embody the functionality and techniques described herein.

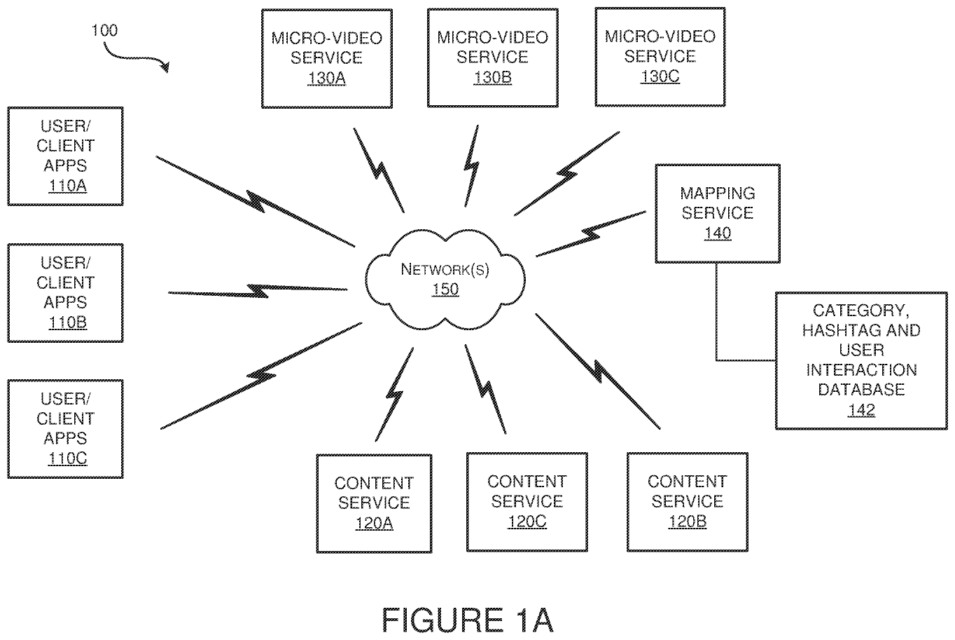

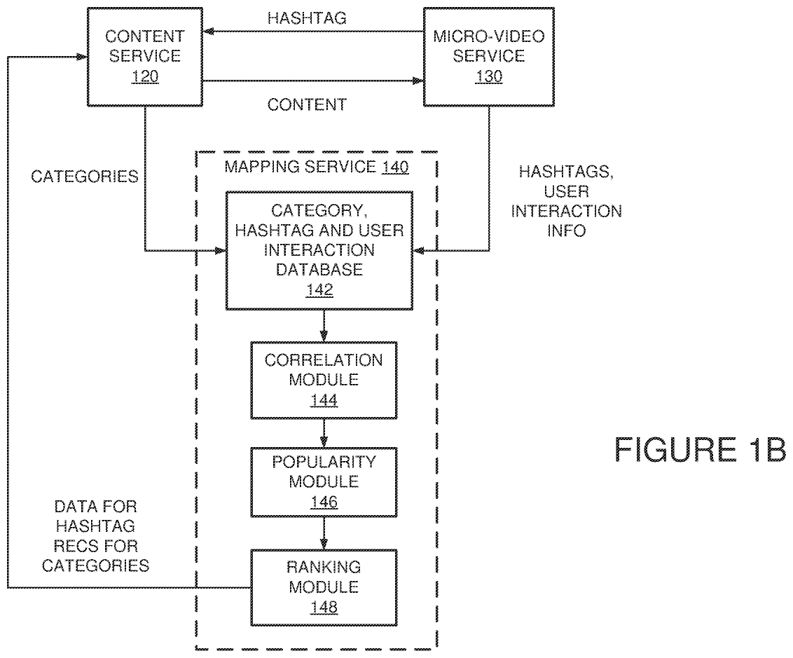

FIG. 1A is an architectural diagram showing an illustrative example of an environment 100 suitable for application of the disclosed technology for mapping micro-video hashtags to content categories. In the example of FIG. 1A, a client, such as a user/client applications 110A-C, content services 120A-C, micro-video services 130A-C and mapping service 140 are in communication with one another via network 150.

Examples of user/client applications 110 can include user client devices, such as mobile smartphone devices or personal computers, or applications executing on user client devices, such as browsers or micro-video applications or communication applications. Examples of content services 120 can include information servers or services, such as news, video, social network, or educational, or eCommerce services.

User/client applications 110 consume micro-video data from micro-video services 130. In this example, micro-video services 130 can collect user interaction information or semantic data that reflects the interests and activities of the users with respect to segments of micro-video content.

FIG. 1B is a functional block diagram showing an illustrative example of a mapping service for mapping micro-video hashtags to content categories in accordance with the disclosed technology. As illustrated in FIG. 1B, mapping service 140 receives category data from content services 120 and hashtag and user interaction data from micro-video services 130 that is stored in database 142 for use in training a graph convolution network to create a model for use in correlation module 144 for providing recommended hashtags for categories to the content services 120.

This example includes a popularity module 146 and ranking module 148 to further filter the hashtag recommendations from correlation module 144 before the hashtag recommendations are provided to the content service 120. Popularity module 146 can filter or weight the recommended hashtags output by correlation module 144 based on one or more measurement indexes, such as post counts, average search volumes or time-aware factors.

Ranking module 148 can determine an order for the hashtag recommendations based on one or more ranking rules, such as relevance, popularity, search volume or post count. In this example, relevance can pertain to the semantically most relevant hashtag recommendations to a content category. Popularity can relate to the most popular hashtags recommended in each category. Search volume can relate to the most searched hashtags within a given time period. Post count can relate to the most often used hashtags.

Content service 120 receives and stores the hashtag recommendations for the categories that are provided by mapping service 140. In this example, micro-video service 130 can provide a hashtag for a micro-video segment being viewed by the user. Content service 120 can determine a content category to which the hashtag is correlated and provide content from that content category to micro-video service 130 for presentation to the user.

In general terms, graph convolution networks have the capability to learn potential information by aggregating the messages from neighbor nodes. For example, information related to the users and hashtags can be filtered using an attention mechanism. In one particular example of an attention mechanism, since hashtags are commonly used by users to express their interest in a micro-video, the correlation module uses a hashtag representation to filter the micro-video information in the corresponding user node representation. Meanwhile, a representation of user preferences can be utilized to filter the micro-video information to model the hashtag semantics, because the user preferences can be used to identify which parts in the micro-video are tagged by the hashtags. Utilizing graph convolution networks can improve user and hashtag representation learning to provide a more effective model in the correlation module 144.

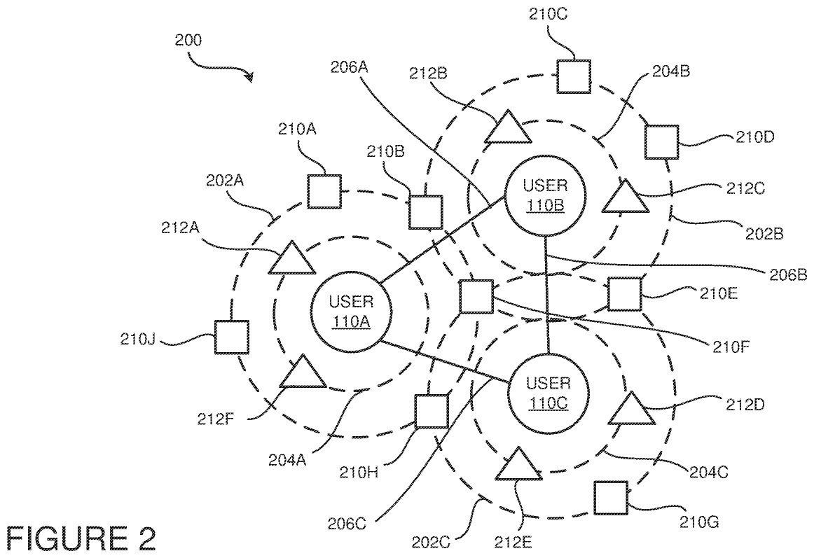

FIG. 2 is a schematic diagram illustrating a simplified example of graph convolution network model 200 that models complex interactions between users, hashtags and micro-videos that can be utilized for hashtag mapping.

In this model example, users 110, micro-video segments 210 and hashtags 212 are three types of nodes in a graph that are linked based on their direct associations. User nodes 110 are connected to or associated with the micro-video nodes 210 that a user has viewed through micro-video information edges 202. User nodes 110 are connected to or associated with the hashtag nodes 212 that the user has used through hashtag information edges 204. User nodes 110 are linked to one another by edges 216.

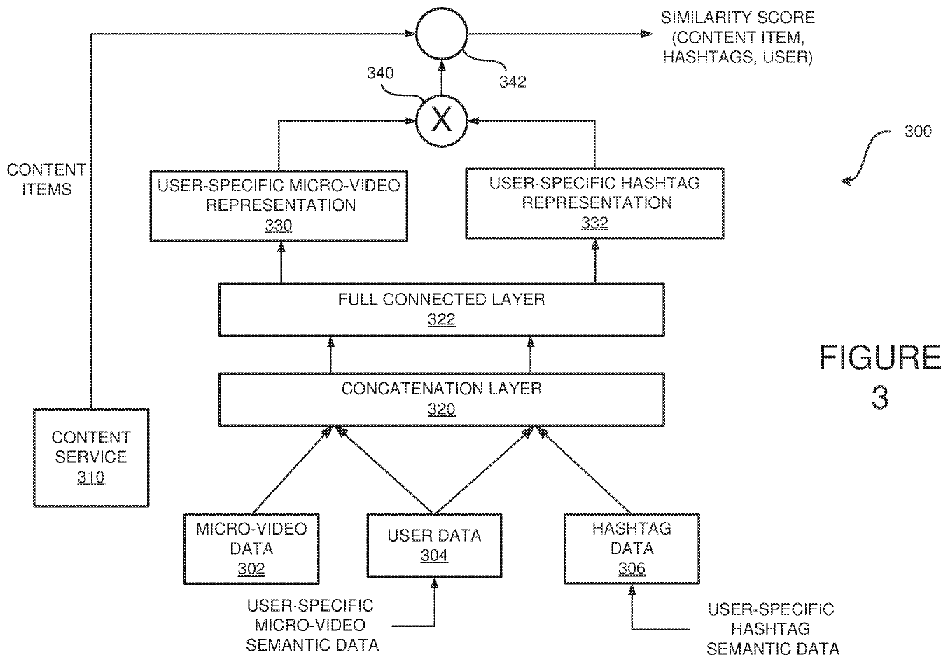

Subsequently, in some examples, the model example can learn user-specific micro-video features and user-specific hashtag semantics with obtained representations of user preference and hashtag semantics, which can then be utilized to calculate a similarity score with respect to content data or items from a content service, e.g. news items from a news content service or products from an e-Commerce platform. In specific examples, the similarity score can be computed by a dot product of the user-specific hashtag representation and the user-specific micro-video representation as is illustrated in the example of FIG. 3.

FIG. 3 is a schematic diagram for an example of a correlation module 300 that utilizes a multi-layer graph convolution network for calculating a similarity score for categories provided by a content service in accordance with the disclosed technology. The multi-layer graph convolution network, in this example, includes a concatenation layer 320 and a full connected layer 322.

In this example, micro-video segment data 302 from a micro-video application is input to concatenation layer 320 along with user data 304, which can include user-specific micro-video semantic data. Hashtag data 306, which can include user-specific hashtag semantic data, is also input to concatenation layer 320 with user data 304. The output of concatenation layer 320, e.g. micro-video data concatenated with user data and hashtag data concatenated with user data, are input to fully connected layer 322.

In other words, micro-video semantics, user semantics and hashtag semantics can be input to concatenation layer 320 of the multi-layer graph convolution network. For example, user-specific and hashtag-specific semantics can be pre-processed and input to the concatenation layer 320 while micro-video semantics without pre-processing can be another input to the concatenation layer 320.

Examples of user-specific semantic data or embeddings can include user text, such as user name, user interaction records relating to micro-videos or video segments as well as followers and influencers. Examples of hashtag-specific semantic data or embeddings can be constructed with hashtag information such as hashtag text, hashtag interaction records relating to micro-videos or video segments as well as followers and influencers. Examples of micro-video-specific semantic data or embeddings can be constructed using video information such as video interaction records relating to micro-videos or video segments as well as followers and influencers. The semantic data information can be graphed to produce a model of the relationships between user, hashtag and micro-video data such as the example shown in FIG. 2.

Full connected layer 322 outputs a user-specific micro-video representation 330 and a user-specific hashtag representation 332. Operator module 340 generates a dot product of the user-specific micro-video representation 330 and user-specific hashtag representation 332 that is used by operator module 342 to calculate a similarity score for content data or items from a content category provided by content service 310 and hashtags for the user.

The similarity score data can be utilized to provide hashtag recommendations for categories, such as those generated by mapping service 140 of FIG. 1. The similarity score data can, in some examples, also be filtered for popularity, e.g. by popularity module 146, and ranked, e.g. by ranking module 148 based on similarity scores, to produce the hashtag recommendations for categories.

The multi-layer graph convolution network utilized in correlation module 300 can perform machine learning to model the complex interactions between users, hashtags and micro-videos, which can be used to learn the similarity between content data or items and hashtags. The learned similarity can then be utilized for mapping hashtags to content categories to identify content of interest to a user.

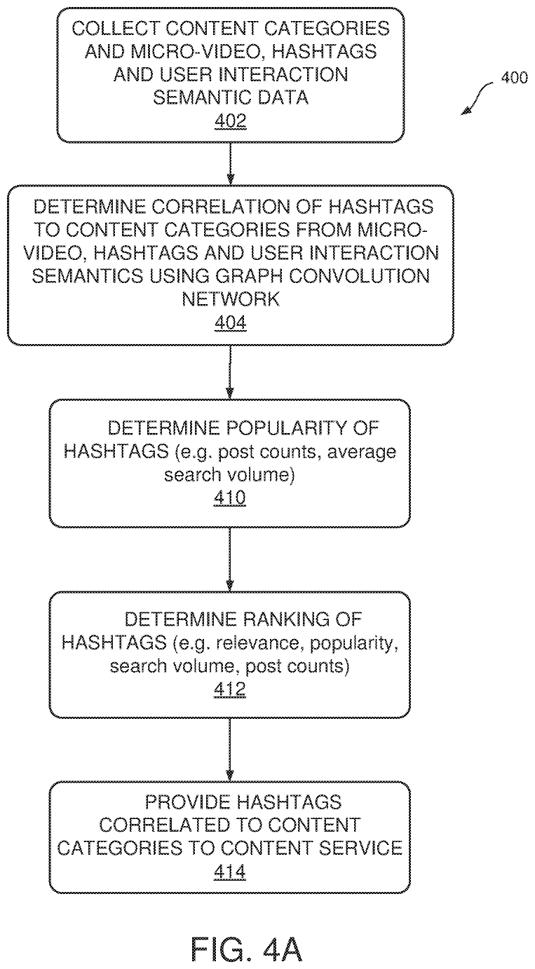

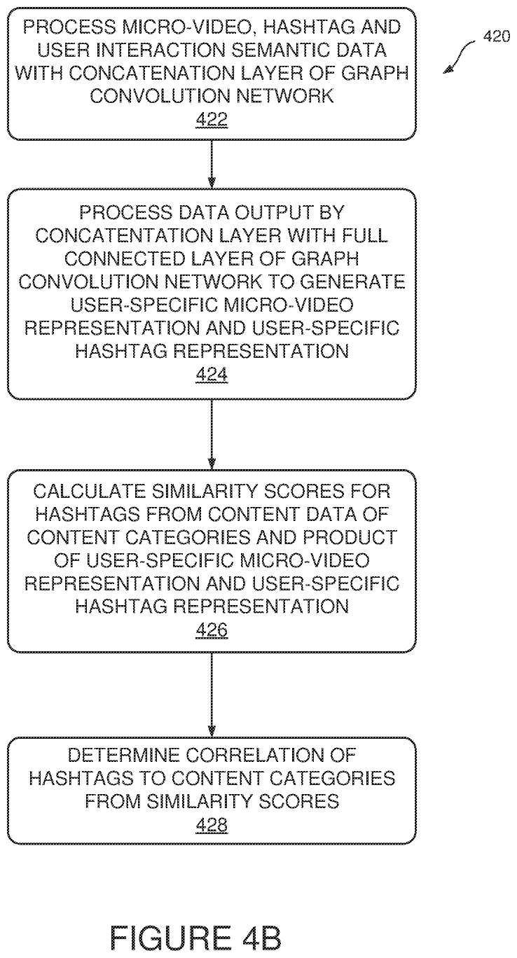

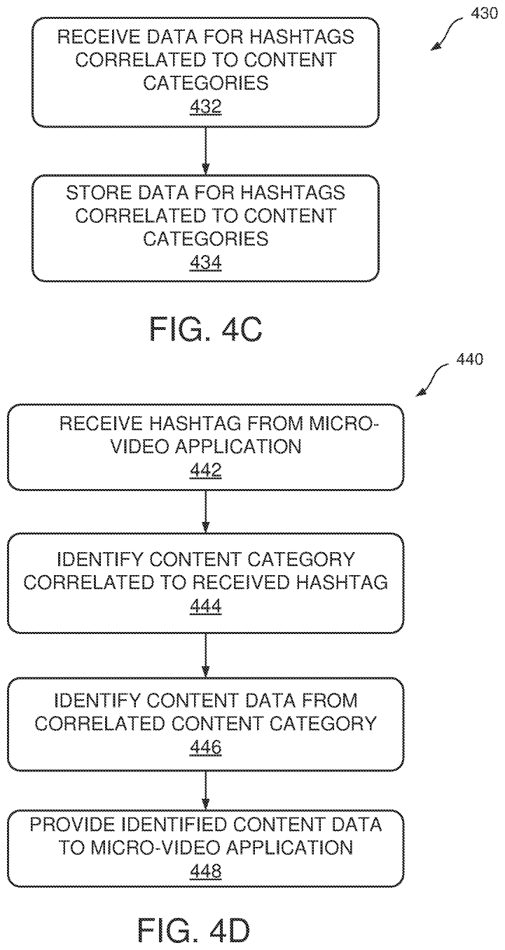

FIG. 4A is a control flow diagram illustrating an example of a process 400 in a mapping service, such as mapping service 140, for mapping micro-video hashtags to content categories using a multi-layer graph convolution network in accordance with the disclosed technology. In general terms, in process 400, content categories are collected from a content service and micro-video, hashtags and user interaction semantic data are collected from one or more micro-video services. A correlation is determined of the content categories to the micro-video, hashtags and user interaction semantic data using a multi-layer graph convolution network.

At 402, process 400 can collect content categories and micro-video, hashtags and user interaction semantic data. At 404, process 400 can determine a correlation of hashtags to content categories from micro-video, hashtags and user interaction semantics using a multi-layer graph convolution network, such as the network illustrated in FIG. 3 having concatenation layer 320 and full connected layer 322. In other words, the micro-video, hashtags and user interaction semantics are input to the multi-layer graph convolution network to determine the correlation of hashtags to content categories.

In some examples, at 410, process 400 can further determine a popularity for each of the hashtags, which can, for example, be based on post counts or average search volume and, at 412, determine a ranking for the hashtags, which can be based on relevance, popularity, search volume, or post counts.

At 414, process 400 can provide the hashtags correlated to content categories to a content service. The content service can utilize the hashtags correlated to content categories to identify content from categories that can be relevant to hashtags. The identified content can be served to a micro-video application in response to hashtags provided by the micro-video application.

FIG. 4B is a control flow diagram illustrating an example of a process 420, such as in operation 404 of FIG. 4A, for determining similarity scores for content categories and hashtags using a multi-layer graph convolution network in accordance with the disclosed technology.

At 422, process 420 can process micro-video, hashtag and user interaction semantic data with a concatenation layer, e.g. concatenation layer 320, of a multi-layer graph convolution network. At 424, process 420 can generate user-specific micro-video representation and a user-specific hashtag representation by processing the data output by the concatenation layer with a full connected layer, e.g. full connected layer 322, of the multi-layer graph convolution network.

At 426, process 420 can calculate similarity scores for hashtags from content of content categories and a product of the user-specific micro-video representation and the user-specific hashtag representation. At 428, process 320 can determine a correlation of the hashtags to the content categories based on the similarity scores. For example, if the similarity scores for a hashtag and a content category exceed a threshold value, then the hashtag can be flagged as correlated to the content category.

FIG. 4C is a control flow diagram illustrating an example of a process 430 in a content service for receiving and storing hashtags correlated to content categories in accordance with the disclosed technology. At 432, the content service receives data for hashtags correlated to content categories and, at 434, stores the data for use in identifying content relevant to hashtags.

FIG. 4D is a control flow diagram illustrating an example of a process 440 in a content service for serving content from categories correlated with hashtags in accordance with the disclosed technology.

At 442, process 440 receives a hashtag from a micro-video application, e.g. a hashtag from a micro-video segment being viewed by the user. At 444, process 440 identifies a content category correlated to the received hashtag. At 446, process 440 identifies content data or items, such as a news posts, information posts, or product descriptions, from the correlated content category. At 448, process 440 provides the identified content data to the micro-video application for display to the user.

It should be appreciated that a variety of different instrumentalities and methodologies can be utilized for mapping micro-video hashtags to content categories without departing from the teachings of the disclosed technology. The disclosed technology provides a high degree of flexibility and variation in the configuration of implementations without departing from the teachings of the present disclosure.

The present techniques may involve operations occurring in one or more machines. As used herein, “machine” means physical data-storage and processing hardware programed with instructions to perform specialized computing operations. It is to be understood that two or more different machines may share hardware components. For example, the same integrated circuit may be part of two or more different machines.

One of ordinary skill in the art will recognize that a wide variety of approaches may be utilized and combined with the present approach to mapping micro-video hashtags to content categories using a multi-layer graph convolution network. The specific examples of different aspects of mapping micro-video hashtags to content categories using a multi-layer graph convolution network described herein are illustrative and are not intended to limit the scope of the techniques shown.

### Computer Architectures for Mapping Micro-Video Hashtags to Content Categories Using a Multi-Layer Graph Convolution Network

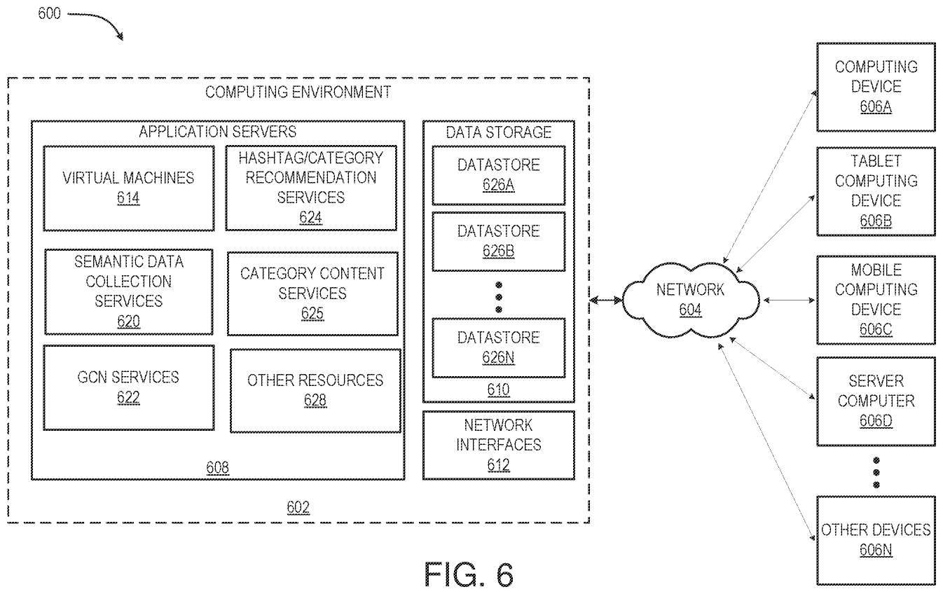

Note that at least parts of processes 400, 420, 430 and 440 of FIGS. 4A, 4B, 4C and 4D and other processes and operations pertaining to mapping micro-video hashtags to content categories using a multi-layer graph convolution network described herein may be implemented in one or more servers, such as computer environment 600 in FIG. 6, or the cloud, and data defining the results of user control input signals translated or interpreted as discussed herein may be communicated to a user device for display. Alternatively, the mapping micro-video hashtags to content categories using a multi-layer graph convolution network processes may be implemented in multiple services implemented on different platforms. In still other examples, some operations may be implemented in one set of computing resources, such as servers, and other steps may be implemented in other computing resources, such as a client device.

It should be understood that the methods described herein can be ended at any time and need not be performed in their entireties. Some or all operations of the methods described herein, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As described herein, in conjunction with the FIGURES described herein, the operations of the routines (e.g. processes 400, 420, 430 and 440 of FIGS. 4A, 4B, 4C and 4D) are described herein as being implemented, at least in part, by an application, component, and/or circuit. Although the following illustration refers to the components of FIGS. 4A-D, it can be appreciated that the operations of the routines may be also implemented in many other ways. For example, the routines may be implemented, at least in part, by a computer processor or a processor or processors of another computer. In addition, one or more of the operations of the routines may alternatively or additionally be implemented, at least in part, by a computer working alone or in conjunction with other software modules.

For example, the operations of routines are described herein as being implemented, at least in part, by an application, component and/or circuit, which are generically referred to herein as modules. In some configurations, the modules can be a dynamically linked library (DLL), a statically linked library, functionality produced by an application programing interface (API), a compiled program, an interpreted program, a script or any other executable set of instructions. Data and/or modules, such as the data and modules disclosed herein, can be stored in a data structure in one or more memory components. Data can be retrieved from the data structure by addressing links or references to the data structure.

Although the following illustration refers to the components of the FIGURES discussed above, it can be appreciated that the operations of the routines (e.g. processes 400, 420, 430 and 440 of FIGS. 4A, 4B, 4C and 4D) may be also implemented in many other ways. For example, the routines may be implemented, at least in part, by a processor of another remote computer or a local computer or circuit. In addition, one or more of the operations of the routines may alternatively or additionally be implemented, at least in part, by a chipset working alone or in conjunction with other software modules. Any service, circuit or application suitable for providing the techniques disclosed herein can be used in operations described herein.

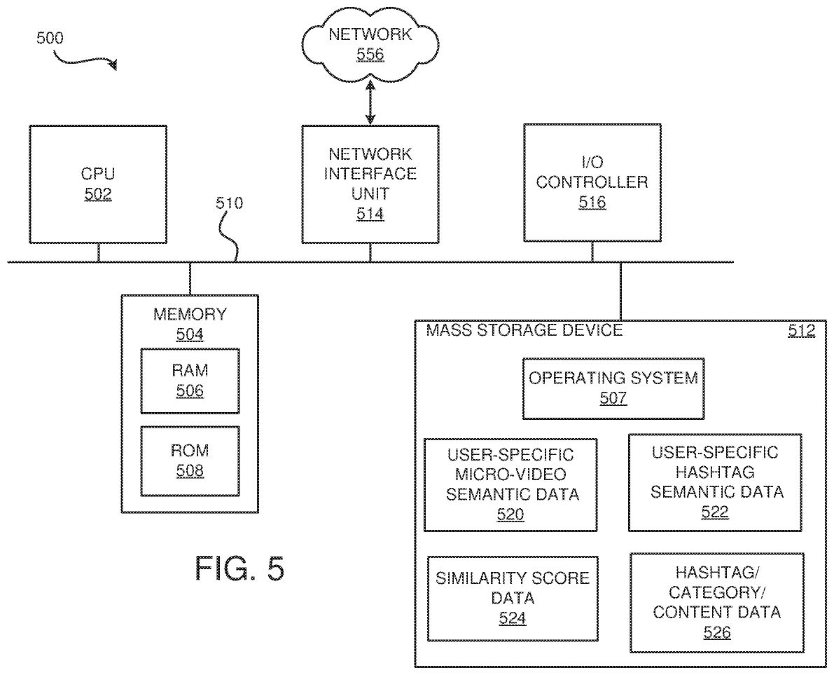

FIG. 5 shows additional details of an example computer architecture 500 for a computer, such as the devices 110, 120, 130 and 140 (FIGS. 1A and 1B), capable of executing the program components described herein. Thus, the computer architecture 500 illustrated in FIG. 5 illustrates an architecture for an on-board vehicle computer, a server computer, mobile phone, a PDA, a smart phone, a desktop computer, a netbook computer, a tablet computer, an on-board computer, a game console, and/or a laptop computer. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between sub-elements within the computer architecture 500, such as during startup, is stored in the ROM 508. The computer architecture 500 further includes a mass storage device 512 for storing an operating system 507, data (such as user-specific micro-video semantic data 520, user-specific hashtag semantic data 522, similarity score data 524, and hashtag to category correlation and content data 526), and one or more application programs.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium,” “computer-readable storage medium” and variations thereof, does not include waves, signals, and/or other transitory and/or intangible communication media, per se.

According to various configurations, the computer architecture 500 may operate in a networked environment using logical connections to remote computers through the network 556 and/or another network (not shown). The computer architecture 500 may connect to the network 556 through a network interface unit 514 connected to the bus 510. It should be appreciated that the network interface unit 514 also may be utilized to connect to other types of networks and remote computer systems. The computer architecture 500 also may include an input/output controller 516 for receiving and processing input from a number of other devices, including a keyboard, mouse, game controller, television remote or electronic stylus (not shown in FIG. 5). Similarly, the input/output controller 516 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

FIG. 6 depicts an illustrative distributed computing environment 600 capable of executing the software components described herein for mapping micro-video hashtags to content categories using a multi-layer graph convolution network. Thus, the distributed computing environment 600 illustrated in FIG. 6 can be utilized to execute many aspects of the software components presented herein. For example, the distributed computing environment 600 can be utilized to execute one or more aspects of the software components described herein.

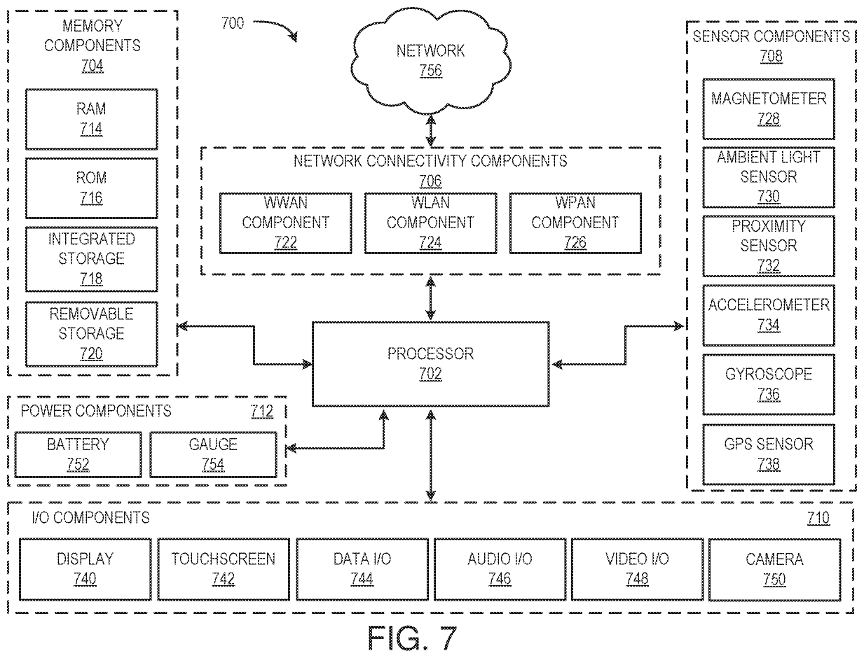

According to various implementations, the distributed computing environment 600 includes a computing environment 602 operating on, in communication with, or as part of the network 604. The network 604 may be or may include the network 556, described above. The network 604 also can include various access networks. One or more client devices 606A-806N (hereinafter referred to collectively and/or generically as “clients 606”) can communicate with the computing environment 602 via the network 604 and/or other connections (not illustrated in FIG. 6). In one illustrated configuration, the clients 606 include a computing device 606A, such as a laptop computer, a desktop computer, or other computing device; a slate or tablet computing device (“tablet computing device”) 606B; a mobile computing device 606C such as a mobile telephone, a smart phone, an on-board computer, or other mobile computing device; a server computer 606D; and/or other devices 606N, which can include a hardware security module. It should be understood that any number of devices 606 can communicate with the computing environment 602. Two example computing architectures for the devices 606 are illustrated and described herein with reference to FIGS. 5 and 7. It should be understood that the illustrated devices 606 and computing architectures illustrated and described herein are illustrative only and should not be construed as being limited in any way.

In the illustrated configuration, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated configuration, the application servers 608 host one or more virtual machines 614 for hosting applications or other functionality. According to various implementations, the virtual machines 614 host one or more applications and/or software modules for mapping micro-video hashtags to content categories using a multi-layer graph convolution network. It should be understood that this configuration is illustrative only and should not be construed as being limiting in any way.

According to various implementations, the application servers 608 also include one or more semantic data collection services 620, multi-layer graph convolution network services 622, hashtag/category recommendation services 624 and category content services 625. The semantic data collection services 620 can includes services for collecting user-specific micro-video semantic data and user-specific hashtag semantic data. The multi-layer graph convolution network services 622 can include services for processing collected data using a multi-layer graph convolution network. The credential and authentication services 624 hashtag/category recommendation services 624 can include services for providing hashtags correlated to content categories provided by a content service. The category content services 625 can include services for serving content relevant to a hashtag from a micro-video application.

As shown in FIG. 6, the application servers 608 also can host other services, applications, portals, and/or other resources (“other resources”) 628. The other resources 628 can include, but are not limited to, data encryption, data sharing, or any other functionality.

As mentioned above, the computing environment 602 can include data storage 610. According to various implementations, the functionality of the data storage 610 is provided by one or more databases or data stores operating on, or in communication with, the network 604. The functionality of the data storage 610 also can be provided by one or more server computers configured to host data for the computing environment 602. The data storage 610 can include, host, or provide one or more real or virtual data stores 626A-826N (hereinafter referred to collectively and/or generically as “datastores 626”). The datastores 626 are configured to host data used or created by the application servers 608 and/or other data. Aspects of the datastores 626 may be associated with services for a mapping micro-video hashtags to content categories using a multi-layer graph convolution network. Although not illustrated in FIG. 6, the datastores 626 also can host or store web page documents, word documents, presentation documents, data structures, algorithms for execution by a recommendation engine, and/or other data utilized by any application program or another module.

The computing environment 602 can communicate with, or be accessed by, the network interfaces 612. The network interfaces 612 can include various types of network hardware and software for supporting communications between two or more computing devices including, but not limited to, mobile client vehicles, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 may provide the software functionality described herein as a service to the clients using devices 606. It should be understood that the devices 606 can include real or virtual machines including, but not limited to, server computers, web servers, personal computers, mobile computing devices, smart phones, and/or other devices, which can include user input devices. As such, various configurations of the concepts and technologies disclosed herein enable any device configured to access the distributed computing environment 600 to utilize the functionality described herein for mapping micro-video hashtags to content categories using a multi-layer graph convolution network, among other aspects.

Turning now to FIG. 7, an illustrative computing device architecture 700 for a computing device that is capable of executing various software components is described herein for mapping micro-video hashtags to content categories using a multi-layer graph convolution network. The computing device architecture 700 is applicable to computing devices such as mobile clients in vehicles. In some configurations, the computing devices include, but are not limited to, mobile telephones, on-board computers, tablet devices, slate devices, portable video game devices, traditional desktop computers, portable computers (e.g., laptops, notebooks, ultra-portables, and netbooks), server computers, game consoles, and other computer systems. The computing device architecture 700 is applicable to the devices 110, 120, 130 and 140 shown in FIGS. 1A-B and computing devices 606A-N shown in FIG. 6.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individual components illustrated in FIG. 7, the components can interact to carry out device functions. In some configurations, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, secure data.

In some configurations, the processor 702 includes a graphics processing unit (“GPU”) configured to accelerate operations performed by the CPU, including, but not limited to, operations performed by executing secure computing applications, general-purpose scientific and/or engineering computing applications, as well as graphics-intensive computing applications such as high resolution video (e.g., 620P, 1080P, and higher resolution), video games, three-dimensional (“3D”) modeling applications, and the like. In some configurations, the processor 702 is configured to communicate with a discrete GPU (not shown). In any case, the CPU and GPU may be configured in accordance with a co-processing CPU/GPU computing model, wherein a sequential part of an application executes on the CPU and a computationally-intensive part is accelerated by the GPU.

In some configurations, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some configurations, the processor 702 is fabricated, in part, utilizing a package-on-package (“PoP”) integrated circuit packaging technique. The processor 702 may be a single core or multi-core processor.

The processor 702 may be created in accordance with an ARM architecture, available for license from ARM HOLDINGS of Cambridge, United Kingdom. Alternatively, the processor 702 may be created in accordance with an x86 architecture, such as is available from INTEL CORPORATION of Mountain View, California and others. In some configurations, the processor 702 is a SNAPDRAGON SoC, available from QUALCOMM of San Diego, California, a TEGRA SoC, available from NVIDIA of Santa Clara, California, a HUMMINGBIRD SoC, available from SAMSUNG of Seoul, South Korea, an Open Multimedia Application Platform (“OMAP”) SoC, available from TEXAS INSTRUMENTS of Dallas, Texas, a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some configurations, the RAM 714 or a portion thereof, the ROM 716 or a portion thereof, and/or some combination of the RAM 714 and the ROM 716 is integrated in the processor 702. In some configurations, the ROM 716 is configured to store a firmware, an operating system or a portion thereof (e.g., operating system kernel), and/or a bootloader to load an operating system kernel from the integrated storage 718 and/or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some configurations, the removable storage 720 is provided in lieu of the integrated storage 718. In other configurations, the removable storage 720 is provided as additional optional storage. In some configurations, the removable storage 720 is logically combined with the integrated storage 718 such that the total available storage is made available as a total combined storage capacity. In some configurations, the total combined capacity of the integrated storage 718 and the removable storage 720 is shown to a user instead of separate storage capacities for the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various configurations, the operating system may include, but is not limited to, server operating systems such as various forms of UNIX certified by The Open Group and LINUX certified by the Free Software Foundation, or aspects of Software-as-a-Service (SaaS) architectures, such as MICROSFT AZURE from Microsoft Corporation of Redmond, Washington or AWS from Amazon Corporation of Seattle, Washington. The operating system may also include WINDOWS MOBILE OS from Microsoft Corporation of Redmond, Washington, WINDOWS PHONE OS from Microsoft Corporation, WINDOWS from Microsoft Corporation, MAC OS or IOS from Apple Inc. of Cupertino, California, and ANDROID OS from Google Inc. of Mountain View, California. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from the network 756 or another network, which may be a WWAN, a WLAN, or a WPAN. Although only the network 756 is illustrated, the network connectivity components 706 may facilitate simultaneous communication with multiple networks, including the network 756 of FIG. 7. For example, the network connectivity components 706 may facilitate simultaneous communications with multiple networks via one or more of a WWAN, a WLAN, or a WPAN.

The network 756 may be or may include a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 756 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 756 may be configured to provide voice and/or data communications with any combination of the above technologies. The network 756 may be configured to or be adapted to provide voice and/or data communications in accordance with future generation technologies.

In some configurations, the WWAN component 722 is configured to provide dual-multi-mode connectivity to the network 756. For example, the WWAN component 722 may be configured to provide connectivity to the network 756, wherein the network 756 provides service via GSM and UMTS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 756 may be a WLAN operating in accordance with one or more Institute of Electrical and Electronic Engineers (“IEEE”) 602.11 standards, such as IEEE 602.11a, 602.11b, 602.11g, 602.11n, and/or future 602.11 standard (referred to herein collectively as WI-FI). Draft 602.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 724 is configured to connect to the network 756 via the WI-FI access points. Such connections may be secured via various encryption technologies including, but not limited to, WI-FI Protected Access (“WPA”), WPA2, Wired Equivalent Privacy (“WEP”), and the like.

The network 756 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 726 is configured to facilitate communications with other devices, such as peripherals, computers, or other computing devices via the WPAN.

The sensor components 708 include a magnetometer 728, an ambient light sensor 730, a proximity sensor 732, an accelerometer 734, a gyroscope 736, and a Global Positioning System sensor (“GPS sensor”) 738. It is contemplated that other sensors, such as, but not limited to, temperature sensors or shock detection sensors, also may be incorporated in the computing device architecture 700.

The I/O components 710 include a display 740, a touchscreen 742, a data I/O interface component (“data I/O”) 744, an audio I/O interface component (“audio I/O”) 746, a video I/O interface component (“video I/O”) 748, and a camera 750. In some configurations, the display 740 and the touchscreen 742 are combined. In some configurations two or more of the data I/O component 744, the audio I/O component 746, and the video I/O component 748 are combined. The I/O components 710 may include discrete processors configured to support the various interfaces described below or may include processing functionality built-in to the processor 702.

The illustrated power components 712 include one or more batteries 752, which can be connected to a battery gauge 754. The batteries 752 may be rechargeable or disposable. Rechargeable battery types include, but are not limited to, lithium polymer, lithium ion, nickel cadmium, and nickel metal hydride. Each of the batteries 752 may be made of one or more cells.

The power components 712 may also include a power connector, which may be combined with one or more of the aforementioned I/O components 710. The power components 712 may interface with an external power system or charging equipment via an I/O component.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The present disclosure is made in light of the following clauses:

Clause 1. A computer implemented method for mapping micro-video hashtags to content categories, the method comprising: collecting content categories from a content service; collecting micro-video, hashtags and user interaction semantic data from one or more micro-video services; determining a correlation of at least one content category to the micro-video, hashtags and user interaction semantic data using a multi-layer graph convolution network; and providing the hashtags correlated with the content category to the content service.

Clause 2. The method of Clause 1, where the method includes: determining popularity levels for the hashtags; determining a ranking of the hashtags based on popularity levels and relevance; and the step of providing the hashtags correlated with the content category to the content service comprises providing the ranking of the hashtags correlated with the content category to the content service.

Clause 3. The method of Clause 1, where: the step of determining a correlation of at least one content category to the micro-video, hashtags and user interaction semantic data using a graph convolution network comprises: processing the micro-video, hashtag and user interaction semantic data with a concatenation layer of the multi-layer graph convolution network; processing data output from the concatenation layer with a full connected layer of the multi-layer graph convolution network to produce a user-specific micro-video representation and a user-specific hashtag representation; and calculating similarity scores for hashtags from content from the content category and a product of the micro-video semantic features and user-specific hashtags, and determining the correlation of hashtags to the content category from the similarity scores.

Clause 4. The method of Clause 3, where: the step of providing the hashtags correlated with the content category to the content service includes providing the similarity scores for the hashtags to the content service.

Clause 5. The method of Clause 1, where the method includes: receiving a hashtag from a micro-video application; identifying a content category correlated to the received hashtag; identifying content from the correlated category; and providing the identified content to the micro-video application for presentation.

Clause 6. The method of Clause 1, where: the content service comprises an information platform, the content category comprises an information category, and the content data from the content category comprises one or more information items.

Clause 7. The method of Clause 1, where: the content service comprises an eCommerce platform, the content category comprises a product category, and the content data from the content category comprises one or more product information items.

Clause 8. A system for mapping micro-video hashtags to content categories, the system comprising: one or more processors; and one or more memory devices in communication with the one or more processors, the memory devices having computer-readable instructions stored thereupon that, when executed by the processors, cause the processors to execute a method for mapping micro-video hashtags to content categories, the method comprising: collecting content categories from a content service; collecting micro-video, hashtags and user interaction semantic data from one or more micro-video services; determining a correlation of at least one content category to the micro-video, hashtags and user interaction semantic data using a multi-layer graph convolution network; and providing the hashtags correlated with the content category to the content service.

Clause 9. The system of Clause 8, where the method includes: determining popularity levels for the hashtags; determining a ranking of the hashtags based on popularity levels and relevance; and the step of providing the hashtags correlated with the content category to the content service comprises providing the ranking of the hashtags correlated with the content category to the content service.

Clause 10. The system of Clause 8, where: the step of determining a correlation of at least one content category to the micro-video, hashtags and user interaction semantic data using a graph convolution network comprises: processing the micro-video, hashtag and user interaction semantic data with a concatenation layer of the multi-layer graph convolution network; processing data output from the concatenation layer with a full connected layer of the multi-layer graph convolution network to produce a user-specific micro-video representation and a user-specific hashtag representation; and calculating similarity scores for hashtags from content from the content category and a product of the micro-video semantic features and user-specific hashtags, and determining the correlation of hashtags to the content category from the similarity scores.

Clause 11. The system of Clause 10, where: the step of providing the hashtags correlated with the content category to the content service includes providing the similarity scores for the hashtags to the content service.

Clause 12. The system of Clause 8, where the method includes: receiving a hashtag from a micro-video application; identifying a content category correlated to the received hashtag; identifying content from the correlated category; and providing the identified content to the micro-video application for presentation.

Clause 13. The system of Clause 8, where: the content service comprises an information platform, the content category comprises an information category, and the content data from the content category comprises one or more information items.

Clause 14. The system of Clause 8, where: the content service comprises an eCommerce platform, the content category comprises a product category, and the content data from the content category comprises one or more product information items.

Clause 15. One or more computer storage media having computer executable instructions stored thereon which, when executed by one or more processors, cause the processors to execute a method for mapping micro-video hashtags to content categories, the method comprising: collecting content categories from a content service; collecting micro-video, hashtags and user interaction semantic data from one or more micro-video services; determining a correlation of at least one content category to the micro-video, hashtags and user interaction semantic data using a multi-layer graph convolution network; and providing the hashtags correlated with the content category to the content service.

Clause 16. The computer storage media of Clause 15, where the method includes: determining popularity levels for the hashtags; determining a ranking of the hashtags based on popularity levels and relevance; and the step of providing the hashtags correlated with the content category to the content service comprises providing the ranking of the hashtags correlated with the content category to the content service.

Clause 17. The computer storage media of Clause 15, where: the step of determining a correlation of at least one content category to the micro-video, hashtags and user interaction semantic data using a graph convolution network comprises: processing the micro-video, hashtag and user interaction semantic data with a concatenation layer of the multi-layer graph convolution network; processing data output from the concatenation layer with a full connected layer of the multi-layer graph convolution network to produce a user-specific micro-video representation and a user-specific hashtag representation; and calculating similarity scores for hashtags from content from the content category and a product of the micro-video semantic features and user-specific hashtags, and determining the correlation of hashtags to the content category from the similarity scores.

Clause 18. The computer storage media of Clause 17, where: the step of providing the hashtags correlated with the content category to the content service includes providing the similarity scores for the hashtags to the content service.

Clause 19. The computer storage media of Clause 15, where the method includes: receiving a hashtag from a micro-video application; identifying a content category correlated to the received hashtag; identifying content from the correlated category; and providing the identified content to the micro-video application for presentation.

Clause 20. The computer storage media of Clause 15, where the content service comprises one of: an information platform, the content category comprises an information category, and the content data from the content category comprises one or more information items; and an eCommerce platform, the content category comprises a product category, and the content data from the content category comprises one or more product information items.

What is claimed is:

1. A computer implemented method for mapping micro-video hashtags to content categories, the method comprising:
collecting content categories from a content service;
collecting micro-video, hashtags and user interaction semantic data from one or more micro-video services;
determining a correlation of at least one content category to the micro-video, hashtags and user interaction semantic data using a multi-layer graph convolution network; and
providing the hashtags correlated with the content category to the content service.

2. The method of claim 1, where the method includes:
determining popularity levels for the hashtags;
determining a ranking of the hashtags based on popularity levels and relevance; and
the step of providing the hashtags correlated with the content category to the content service comprises providing the ranking of the hashtags correlated with the content category to the content service.

3. The method of claim 1, where:
the step of determining a correlation of at least one content category to the micro-video, hashtags and user interaction semantic data using a graph convolution network comprises:
processing the micro-video, hashtag and user interaction semantic data with a concatenation layer of the multi-layer graph convolution network;
processing data output from the concatenation layer with a full connected layer of the multi-layer graph convolution network to produce a user-specific micro-video representation and a user-specific hashtag representation; and
calculating similarity scores for hashtags from content from the content category and a product of the micro-video semantic features and user-specific hashtags, and
determining the correlation of hashtags to the content category from the similarity scores.

4. The method of claim 3, where:
the step of providing the hashtags correlated with the content category to the content service includes providing the similarity scores for the hashtags to the content service.

5. The method of claim 1, where the method includes:
receiving a hashtag from a micro-video application;
identifying a content category correlated to the received hashtag;
identifying content from the correlated category; and
providing the identified content to the micro-video application for presentation.

6. The method of claim 1, where:
the content service comprises an information platform, the content category comprises an information category, and the content data from the content category comprises one or more information items.

7. The method of claim 1, where:
the content service comprises an eCommerce platform, the content category comprises a product category, and the content data from the content category comprises one or more product information items.

8. A system for mapping micro-video hashtags to content categories, the system comprising:
one or more processors; and
one or more memory devices in communication with the one or more processors, the memory devices having computer-readable instructions stored thereupon that, when executed by the processors, cause the processors to execute a method for mapping micro-video hashtags to content categories, the method comprising:
collecting content categories from a content service;
collecting micro-video, hashtags and user interaction semantic data from one or more micro-video services;
determining a correlation of at least one content category to the micro-video, hashtags and user interaction semantic data using a multi-layer graph convolution network; and
providing the hashtags correlated with the content category to the content service.

9. The system of claim 8, where the method includes:
determining popularity levels for the hashtags;
determining a ranking of the hashtags based on popularity levels and relevance; and
the step of providing the hashtags correlated with the content category to the content service comprises providing the ranking of the hashtags correlated with the content category to the content service.

10. The system of claim 8, where:
the step of determining a correlation of at least one content category to the micro-video, hashtags and user interaction semantic data using a graph convolution network comprises:
processing the micro-video, hashtag and user interaction semantic data with a concatenation layer of the multi-layer graph convolution network;
processing data output from the concatenation layer with a full connected layer of the multi-layer graph convolution network to produce a user-specific micro-video representation and a user-specific hashtag representation; and
calculating similarity scores for hashtags from content from the content category and a product of the micro-video semantic features and user-specific hashtags, and
determining the correlation of hashtags to the content category from the similarity scores.

11. The system of claim 10, where:
the step of providing the hashtags correlated with the content category to the content service includes providing the similarity scores for the hashtags to the content service.

12. The system of claim 8, where the method includes:
receiving a hashtag from a micro-video application;
identifying a content category correlated to the received hashtag;
identifying content from the correlated category; and
providing the identified content to the micro-video application for presentation.

13. The system of claim 8, where:
the content service comprises an information platform, the content category comprises an information category, and the content data from the content category comprises one or more information items.

14. The system of claim 8, where:
the content service comprises an eCommerce platform, the content category comprises a product category, and the content data from the content category comprises one or more product information items.

15. One or more computer storage media having computer executable instructions stored thereon which, when executed by one or more processors, cause the processors to execute a method for mapping micro-video hashtags to content categories, the method comprising:
collecting content categories from a content service;
collecting micro-video, hashtags and user interaction semantic data from one or more micro-video services;
determining a correlation of at least one content category to the micro-video, hashtags and user interaction semantic data using a multi-layer graph convolution network; and
providing the hashtags correlated with the content category to the content service.

16. The computer storage media of claim 15, where the method includes:
determining popularity levels for the hashtags;
determining a ranking of the hashtags based on popularity levels and relevance; and
the step of providing the hashtags correlated with the content category to the content service comprises providing the ranking of the hashtags correlated with the content category to the content service.

17. The computer storage media of claim 15, where:
the step of determining a correlation of at least one content category to the micro-video, hashtags and user interaction semantic data using a graph convolution network comprises:
processing the micro-video, hashtag and user interaction semantic data with a concatenation layer of the multi-layer graph convolution network;
processing data output from the concatenation layer with a full connected layer of the multi-layer graph convolution network to produce a user-specific micro-video representation and a user-specific hashtag representation; and
calculating similarity scores for hashtags from content from the content category and a product of the micro-video semantic features and user-specific hashtags, and
determining the correlation of hashtags to the content category from the similarity scores.

18. The computer storage media of claim 17, where:
the step of providing the hashtags correlated with the content category to the content service includes providing the similarity scores for the hashtags to the content service.

19. The computer storage media of claim 15, where the method includes:
receiving a hashtag from a micro-video application;
identifying a content category correlated to the received hashtag;
identifying content from the correlated category; and
providing the identified content to the micro-video application for presentation.

20. The computer storage media of claim 15, where the content service comprises one of:
an information platform, the content category comprises an information category, and the content data from the content category comprises one or more information items; and
an eCommerce platform, the content category comprises a product category, and the content data from the content category comprises one or more product information items.
